(19) United States
(12) Patent Application Publication
(10) Pub. No.: US 2018/0217490 A1
(43) Pub. Date: Aug. 2, 2018

(54) 3D PROJECTION SYSTEM

(71) Applicant: SAMSUNG ELECTRONICS CO., LTD., Suwon-si (KR)

(72) Inventors: Bongsu Shin, Seoul (KR); Dongouk Kim, Pyeongtaek-si (KR); Joonyong Park, Suwon-si (KR); Jihyun Bae, Seoul (KR); Dongsik Shim, Hwaseong-si (KR); Sunghoon Lee, Suwon-si (KR); Jaeseung Chung, Seoul (KR)

(73) Assignee: SAMSUNG ELECTRONICS CO., LTD., Suwon-si (KR)

(21) Appl. No.: 15/791,518

(22) Filed: Oct. 24, 2017

(30) Foreign Application Priority Data
Feb. 2, 2017 (KR) 10-2017-0015126

(51) Int. Cl. G03B 35/20; G02B 27/01; G03B 21/60; G03B 21/62; G03B 21/58; H04N 13/04; H04N 9/31; B60K 35/00

(52) U.S. Cl. CPC G03B 35/20; B60K 2350/921; G03B 21/60; G03B 21/62; G03B 21/58; H04N 13/0418; H04N 9/3147; H04N 13/0459; H04N 9/3129; B60K 35/00; H04N 2213/001; B60K 2350/2052; B60K 2350/2017; B60K 2350/203; G02B 27/0101

(57) ABSTRACT

There is provided a three-dimensional (3D) projection system including a diffraction element having a grating pattern and a plurality of projectors that project light having image information onto the diffraction element. The diffraction element displays a 3D image at multiple viewing points by adjusting a light exit direction based on an incident angle of the light projected by each of the plurality of projectors at the grating pattern.

### CROSS-REFERENCE TO RELATED APPLICATION

This application claims priority from Korean Patent Application No. 10-2017-0015126, filed on Feb. 2, 2017, in the Korean Intellectual Property Office, the disclosure of which is incorporated herein in its entirety by reference.

### BACKGROUND

### 1. Field

The present disclosure relates to a three-dimensional (3D) projection system which forms multi-view by using a plurality of projectors.

### 2. Description of the Related Art

Three-dimensional (3D) image display apparatuses display a 3D image based on binocular parallax. Related art 3D image display apparatuses use binocular parallax of two eyes. For example, a viewer may feel a 3D effect, when an image for a left eye and an image for a right eye, which are seen from different viewing points, are respectively provided to the left eye and the right eye. The 3D image display apparatus may include a glasses type technique requiring special glasses and a non-glasses type technique requiring no glasses.

In the glasses type technique, different images are seen by the two eyes of a user wearing special glasses such as polarized glasses or shutter-type glasses. However, the glasses type technique causes inconvenience to customers who are reluctant to use glasses. To address the inconvenience, non-glasses type 3D image display apparatuses have been widely researched.

### SUMMARY

Provided are methods and apparatuses for a three-dimensional (3D) projection system capable of increasing the number of multi-views by using a plurality of projectors.

Additional aspects will be set forth in part in the description which follows and, in part, will be apparent from the description, or may be learned by practice of the presented embodiments.

According to an exemplary embodiment, there is provided a three-dimensional (3D) projection system comprising: a diffraction element comprising a grating pattern; and a plurality of projectors configured to project light having image information onto the diffraction element, wherein the diffraction element displays a 3D image at multiple viewing points by adjusting a light exit direction based on an incident angle of the light projected by each of the plurality of projectors at the grating pattern.

Each of the plurality of projectors may comprise: an illuminator configured to irradiating light; an optical modulator configured to control the light in units of pixels, and a controller configured to control the optical modulator to form an image.

The 3D projection system may further comprise: a screen which comprises the diffraction element.

The plurality of projectors may be arranged at a left portion, a center portion and a right portion in a horizontal direction of the screen.

Each of the plurality of projectors may comprise a scanner configured to scan light including image information with respect to the screen.

Each of the plurality of projectors may further comprise: an optical modulator having a plurality of pixels to form an image, and the plurality of pixels of the optical modulator are configured to have a one-to-one match with the grating pattern of the diffraction element.

Each of the plurality of projectors may further comprise a scanner controller configured to change a scanning angle of the scanner such that the grating pattern of the screen and pixel image signals of optical modulator have a one-to-one match.

The screen may further comprises at least one alignment mark, and each of the plurality of projectors may comprises a position detection sensor configured to detect a position of the at least one alignment mark.

The plurality of projectors may be arranged in a horizontal direction of the screen to form multi-view in the horizontal direction, and arranged in a vertical direction of the screen to form multi-view in the vertical direction.

The plurality of projectors may be arranged to be spaced apart from the screen.

Each of the plurality of projectors may further comprise a beam adjustor configured to expand the light having the image information formed by the optical modulator.

The diffraction element may be of a semi-transmissive type, and the diffraction element may reflect the image formed by the plurality of projectors to be displayed in front of the screen and transmit a real object image to be displayed behind of the screen.

The screen may correspond to a car front glass and is implemented in a vehicle.

The screen and the plurality of projectors may be provided in a vehicle, and a 3D image diffracted by the diffraction element of the screen may be displayed on a car front glass.

The screen and the plurality of projectors may be coupled to a mobile device.

The screen may be slidably coupled to the mobile device or may be coupled to the mobile device to be foldable.

The screen may be opaque, and the light having the image information is diffracted by the diffraction element and the image may be displayed in a front direction of the screen.

The diffraction element may be integrally formed in the screen.

According to another exemplary embodiment, there is provided a three-dimensional (3D) projection system comprising: a diffraction element comprising a grating pattern; a first projector configured to project a first light having image information onto the diffraction element; and a second projector configured to project a second light having the image information onto the diffraction element, wherein light exit direction of the first light and the second light at the diffraction element are controlled based on an interaction between the first projection and the grating pattern, and based on an interaction between the second projector and the grating pattern.

According to another exemplary embodiment, there is provided a method for displaying a three-dimensional (3D) image comprising: projecting, by a first projector, a first light having image information onto a diffraction element comprising a grating pattern; and projecting, by a second projector, a second light having the image information onto the diffraction element, wherein light exit direction of the first light and the second light at the diffraction element are controlled based on an interaction between the first projection and the grating pattern, and based on an interaction between the second projector and the grating pattern.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 schematically illustrates a three-dimensional (3D) projection system according to an exemplary embodiment;

FIG. 2 illustrates a diffraction element of a 3D projection system according to an exemplary embodiment;

FIG. 3 is a partially enlarged view of the diffraction element of FIG. 2 according to an exemplary embodiment;

FIG. 4 illustrates multi-view of a 3D projection system according to an exemplary embodiment;

FIG. 5 is a block diagram of an example of a projector employed by a 3D projection system according to an exemplary embodiment;

FIG. 6 is a drawing for explaining a scanning operation of a 3D projection system according to an exemplary embodiment;

FIG. 7 is a block diagram of another example of a projector employed by a 3D projection system according to an exemplary embodiment;

FIG. 8 illustrates that a 3D image is displayed by a 3D projection system according to an exemplary embodiment;

FIG. 9 illustrates an example in which at least one alignment mark is further provided in the 3D projection system of FIG. 1 according to an exemplary embodiment;

FIG. 10 is a block diagram of another example of a projector employed by a 3D projection system according to an exemplary embodiment;

FIG. 11 illustrates an example in which a 3D projection system according to an exemplary embodiment is applied to a vehicle;

FIG. 12 illustrates another example in which a 3D projection system according to an exemplary embodiment is applied to a vehicle;

FIG. 13 illustrates an example in which a 3D projection system according to an exemplary embodiment is applied to a wrist-type mobile device;

FIG. 14 illustrates an example in which a 3D projection system according to an exemplary embodiment is applied to a smartphone;

FIG. 15 illustrates an example in which a 3D projection system according to an exemplary embodiment is applied to a tablet; and

FIG. 16 illustrates an example in which a plurality of projectors are arranged in horizontal and vertical directions of a screen in a 3D projection system according to an exemplary embodiment.

### DETAILED DESCRIPTION

Reference will now be made in detail to embodiments, examples of which are illustrated in the accompanying drawings, wherein like reference numerals refer to like elements throughout. Also, the size of each layer illustrated in the drawings may be exaggerated for convenience of explanation and clarity. In this regard, the present embodiments may have different forms and should not be construed as being limited to the descriptions set forth herein. Accordingly, the embodiments are merely described below, by referring to the figures, to explain aspects of the present description Hereinafter, a three-dimensional (3D) projection system according to an embodiment is described in detail with reference to the accompanying drawings.

Like reference numerals in the drawings denote like elements. Sizes of components in the drawings may be exaggerated for convenience of explanation. Terms such as “first” and “second” are used herein merely to describe a variety of constituent elements, but the constituent elements are not limited by the terms. Such terms are used only for the purpose of distinguishing one constituent element from another constituent element.

An expression used in a singular form in the present specification also includes the expression in its plural form unless clearly specified otherwise in context. When a part may “include” a certain constituent element, unless specified otherwise, it may not be construed to exclude another constituent element but may be construed to further include other constituent elements.

Furthermore, terms such as “unit”, “module”, etc. stated in the specification may signify a unit to process at least one function or operation and the unit may be embodied by hardware, software, or a combination of hardware and software. Furthermore, when a constituent element A is disposed “above” or “on” to another constituent element B, it may be interpreted that the constituent element A is provided directly on the other constituent element B or above the other constituent element B in a non-contact manner.

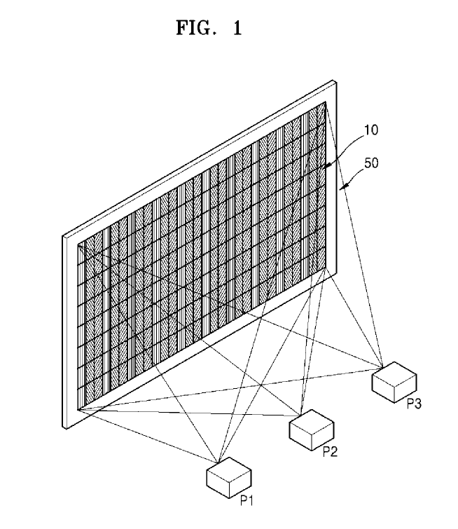

FIG. 1 schematically illustrates an overall configuration of a 3D projection system according to an exemplary embodiment.

Referring to FIG. 1, the 3D projection system according to the exemplary embodiment may include a screen 50 including a diffraction element 10, and a plurality of projectors projecting images onto the screen 50. The projectors may include, for example, a first projector P1, a second projector P2, and a third projector P3. The number of projectors is not limited thereto, and may be changed according to the number of viewing points of an image and an angle of view. The projectors may be arranged, for example, at the center with respect to the horizontal direction of the screen 50 and at the left and right to the screen 50. The projectors may be arranged symmetrically to the left and right with respect to the horizontal direction of the screen 50.

Each of the first projector P1, the second projector P2, and the third projector P3 may project light having information about a 3D image onto the screen 50. Each of the first projector P1, the second projector P2, and the third projector P3 may be arranged to be spaced apart from the screen 50.

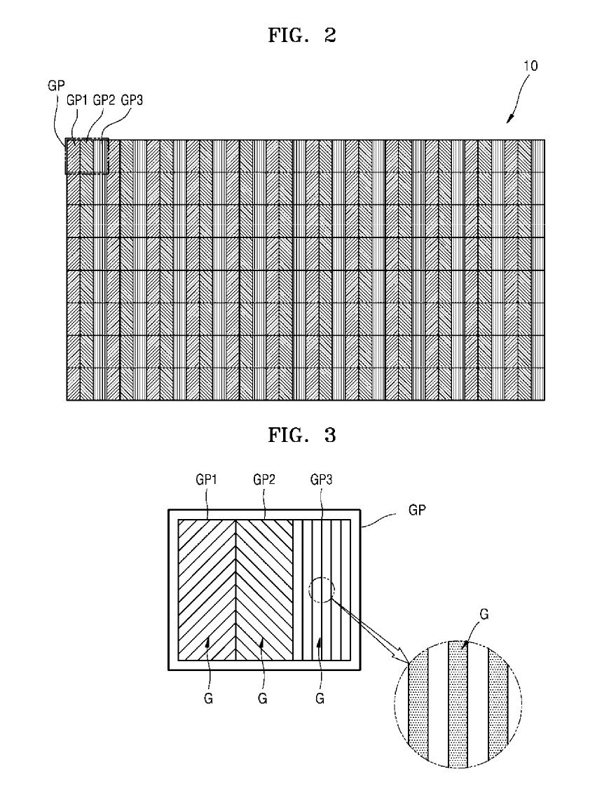

Referring to FIG. 2, according to an exemplary embodiment, the diffraction element 10 may include a grating pattern (diffraction pattern) GP to adjust a light exit direction according to at least one of an incident angle and a wavelength of light. For example, the direction in which the light exits from the diffraction element 10 may vary according to the incident angle of the light emitted from the projectors and including image information with respect to the diffraction element 10. Furthermore, the diffraction element 10 may be configured to have selectivity with respect to the wavelength of light. In other words, the diffraction element 10 may include a grating pattern GP that is configured to react only to light of a particular wavelength band.

FIG. 3 schematically illustrates the grating pattern GP of the diffraction element 10 according to an exemplary embodiment. The grating pattern GP may include a plurality of sub-grating patterns.

For example, the grating pattern GP may include a first sub-grating pattern GP1, a second sub-grating pattern GP2, a third sub-grating pattern GP3. For example, the first sub-grating pattern GP1 may react to a first wavelength light, the second sub-grating pattern GP2 may react to a second wavelength light, and the third sub-grating unit GP3 may react to a third wavelength light. The respective sub-grating patterns may be different in the arrangement direction of grating G.

The diffraction element 10 may have a plurality of grating pattern sets in which the light exit direction is determined according to at least one of the direction and wavelength of light incident on the diffraction element 10. The grating pattern set may indicate a unit of displaying an image for one view. The diffraction element 10 may output light in a specific direction according to a combination of a pitch of the grating G, an arrangement direction of the grating G, a refractive index of the grating G, a duty cycle of the grating G, a traveling direction of light, and a relative angle with respect to the grating G.

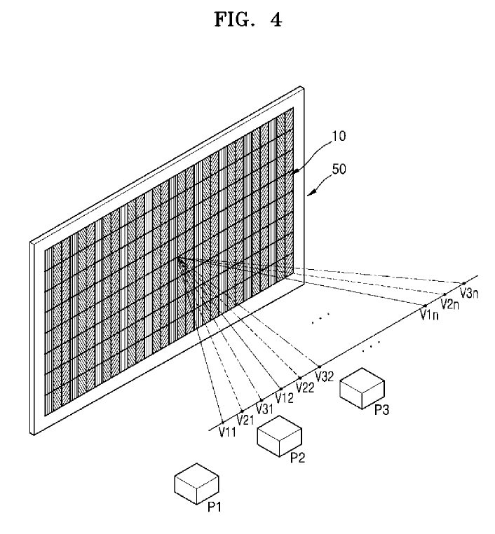

The diffraction element 10 may allow light to exit in different directions according to the grating pattern set. The light exiting in different directions may display a 3D image by providing different views. The view may indicate, for example, an image seen by one eye of a viewer. However, the present disclosure is not limited thereto and it is possible to provide an image corresponding to two or more views to one eye of the viewer. The diffraction element 10 may control the light exit direction, and when different views according to the light exit direction are provided to the viewer, a 3D image may be displayed. A plurality of views, for example, thirty-six (36) views, forty-eight (48) views, or ninety-six (96) views may be provided according to the number of the grating pattern sets. According to the exemplary embodiment, the number of views may be doubled according to the number of projectors. Referring to FIG. 4, the n-number of views V11, V12, . . . V1n may be generated by the first projector P1, the n-number of views V21, V22, . . . V2n may be generated by the second projector P2, and the n-number of views V31, V32, . . . V3n may be generated by the third projector P3.

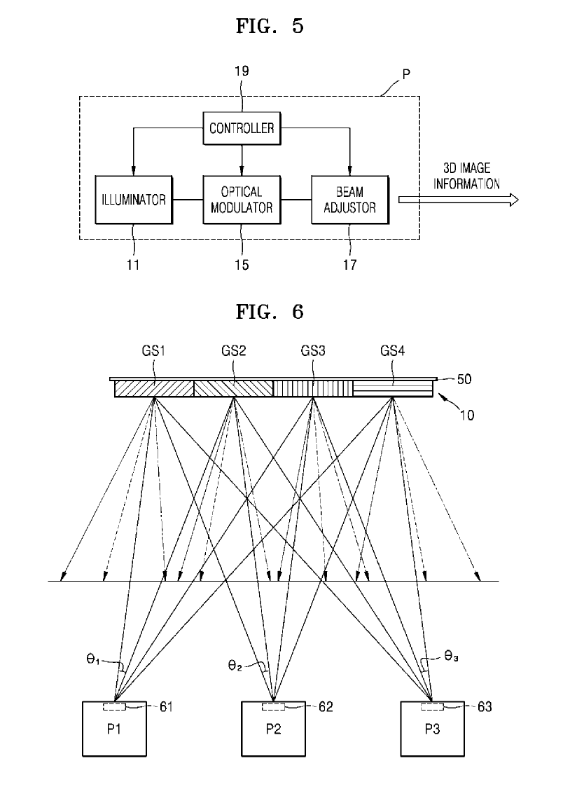

FIG. 5 is a schematic block diagram of a configuration of a projector P according to an exemplary embodiment. The projector P may include, for example, an illuminator 11 for irradiating light, an optical modulator 15 for controlling the light in unit of pixels, a controller 19 for controlling the optical modulator 15 to form an image. The pixel may be, for example, a unit capable of controlling transmittance of light. The pixel may include a plurality of sub-pixels. The sub-pixel may be a unit capable of controlling selection of the wavelength of light with the transmittance of light. The grating pattern GP of the diffraction element 10 may correspond to the pixel of the optical modulator 15. A sub-grating pattern may correspond to sub-pixels based on a color.

Furthermore, the projector P may further include a beam adjustor 17 for expanding light having information about a 3D image. The beam adjustor 17 may be a lens system capable of adjusting, for example, a focal length.

FIG. 6 schematically illustrates that the light exit direction is controlled by the interaction of a plurality of projectors and the grating pattern set according to an exemplary embodiment. Although FIG. 6 illustrates an example in which the diffraction element 10 is separately provided in the screen 50, the screen 50 and the diffraction element 10 may be formed in one body. In other words, the diffraction element 10 itself may be a screen. The diffraction element 10 may include a plurality of grating pattern sets, for example, first to fourth grating pattern sets GS1, GS2, GS3, and GS4. Although the grating pattern set is configured as a grating pattern array, the grating pattern set is simply illustrated in the drawing for convenience of explanation.

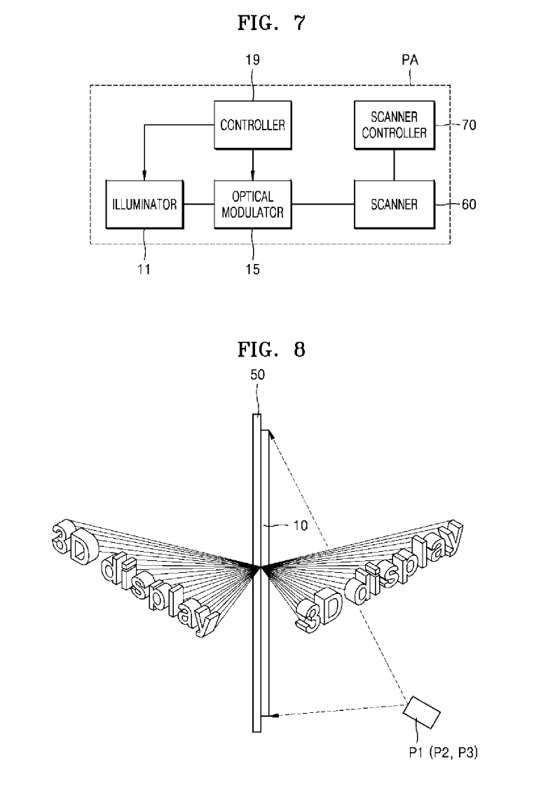

FIG. 7 illustrates another example of a projector PA. The projector PA may include, for example, the illuminator 11 for irradiating light, the optical modulator 15 for controlling light in units of pixels, and the controller 19 for controlling the optical modulator 15 to form a 3D image. Furthermore, the projector PA may include a scanner 60 for scanning light including 3D image information from the optical modulator 15 (hereinafter, referred to as the image light) onto the screen 50. The project PA may include a scanning controller 70 for controlling the scanner 60.

Referring to FIG. 6, the first projector P1 may include a first scanner 61, the second projector P2 may include a second scanner 62, and the third projector P3 may include a third scanner 63. The scanner may be implemented in various methods, for example, an MEMS mirror or a Galvano mirror. Each scanner may perform scanning with different scanning angles 81, 82, and 83 according to the position of a projector. The scanning angle may indicate a scanning angle between neighboring grating pattern sets during scanning. The scanning angle of each projector may be set corresponding to a relative positional relation between each of the projectors P1, P2, and P3 and the diffraction element 10. The scanner controller 70 may control a scanning speed such that the scanners 61, 62, and 63 are in synchronism with the sub-grating patterns formed corresponding to the respective colors.

For the second projector P2 located corresponding to a center portion of the screen 50, the scanning angle 82 is symmetric during scanning from the left to the right on the drawing. For the first projector P1 and the third projector P3 located corresponding to the left and right sides of the screen 50, the scanning angles 81 and 83 may be asymmetric. When the first projector P1 irradiates image light onto the screen 50, the first scanner 61 may scan the image light along the grating pattern array. The first projector P1 is located at the left side of the screen 50 on the drawing, and the scanning angle 81 may gradually decrease when scanning is performed from the left to the right of the screen 50. When the second projector P2 performs scanning from the left to the right of the screen 50, the scanning angle 82 may be identical. When the third projector P3 performs scanning from the left to the right of the screen 50, the scanning angle 83 may gradually increase.

The projectors P1, P2, and P3 may be easy to adjust a distribution of light incident angles on the screen 50 and may be possible to select an angle suitable for diffraction. For example, color and brightness of the light from each of the projectors P1, P2, and P3 may be adjusted for each pixel through a modulation process. The image light output by each of the projectors P1, P2, and P3 is an image rendered in association with the structure of the grating pattern GP, and the number of projectors and the diffraction angle and amount of the grating pattern GP or the sub-grating pattern may be determined based on the number of views to be embodied and an angle of view.

Since 3D projection systems according to various exemplary embodiments employ a method of adjusting a direction of emitting a projector image, various output methods may be employed by the projectors P1, P2, and P3. For example, each of the projectors P1, P2, and P3 may employ a one-shot method, a single-spot beam scanning method, a line-beam scanning method, or a time sequential output method, and a 3D image to be displayed may be generated by using the above methods. To this end, the optical modulator 15 of each of the projectors P1, P2, and P3 may be controlled by the controller 19.

The diffraction element 10 may be manufactured in a reflection type or a semi-transmissive type. In the case of a reflective diffraction element, a 3D image formed by being diffracted by the grating pattern GP of the screen 50 may be in front of the screen 50. When the diffraction element 10 is of a semi-transmissive type, a 3D image may be displayed both in front of and at the back of the screen 50 as illustrated in FIG. 8 according to an exemplary embodiment. According to an exemplary embodiment, the front direction of the screen 50 may indicate a direction toward each of the projectors P1, P2, and P3 with respect to the screen 50, and the rear direction may indicate an opposite direction with respect to the screen 50.

In the grating pattern GP, since a grating pitch is formed in a period of, for example, about several hundreds of nanometers (nm), the diffraction element 10 may be substantially transparent. Accordingly, when the grating pattern GP is formed on the screen 50 itself, the screen 50 may be operated as a semi-transmissive type screen.

When the diffraction element 10 is separately provided in the screen 50, and the screen 50 is transparent and the diffraction element 10 is of a semi-transmissive type, a 3D image may be displayed in both of the opposite directions of the screen 50. In this case, a see-through 3D display in which a real object image in the rear direction of the screen 50 is displayed by passing through the screen 50 may be implemented.

When the diffraction element 10 is separately provided in the screen 50, and the screen 50 is opaque, a reflective 3D projection system in which a 3D image is displayed only in the front direction of the screen 50 may be implemented.

Since a 3D projection system according to the exemplary embodiment uses an image generated by a projector, the 3D projection system does not use a light guide plate unlike a 3D display employing a directional backlight unit, and thus, a loss generated while light is guided by the light guide plate may be reduced. Furthermore, since each of the projectors P1, P2, and P3 is capable of directly irradiating the image light onto the screen 50, no uniformity problem may be generated. Furthermore, as the illuminator 11 and the optical modulator 15 are provided in each of the projectors P1, P2, and P3, the structure of the screen 50 may be simplified and applied to various products.

A 3D projection system according to an exemplary embodiment may display a two-dimensional (2D) image when the screen 50 is replaced with a general screen having no grating pattern, and each of the projectors P1, P2, and P3 are controlled to provide light having 2D image information. As such, the 3D projection system according to the exemplary embodiment may be capable of switching between 2D and 3D by replacing the screen only.

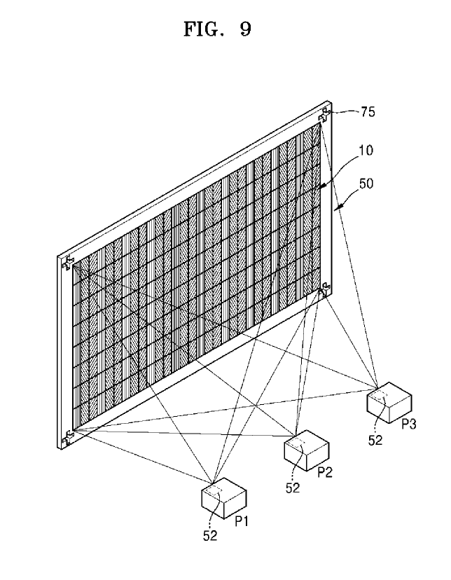

FIG. 9 illustrates an example in which an alignment mark 75 is further provided in the 3D projection system of FIG. 1 according to an exemplary embodiment.

The screen 50 may be provided with at least one alignment mark 75. FIG. 9 illustrates an example in which the alignment mark 75 is provided at each corner of the screen 50 according to an exemplary embodiment.

Each of the projectors P1, P2, and P3 may further include a position detection sensor 52 for detecting the position of the alignment mark 75 of the screen 50. The position detection sensor 52 may be provided in each of the projectors P1, P2, and P3 or separately from each of the projectors P1, P2, and P3.

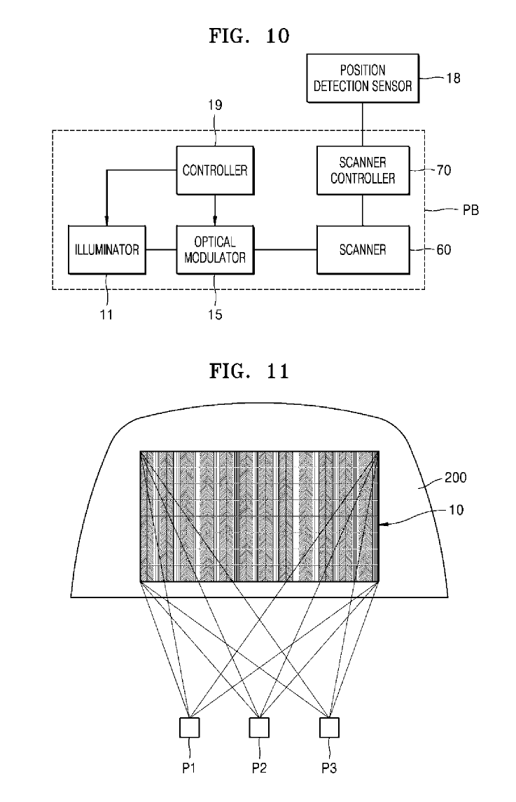

FIG. 10 is a block diagram of another example of a projector PB employed by a 3D projection system according to an exemplary embodiment. The projector PB may include, for example, the illuminator 11 for irradiating light, the optical modulator 15 for controlling light in units of pixels, and the controller 19 for controlling the optical modulator 15 to form a 3D image. Furthermore, the projector PB may include the scanner 60 for scanning the image light from the optical modulator 15 onto the screen 50, and the scanner controller 70 for controlling the scanner 60. Furthermore, the projector PB may further include a position detection sensor 18 for detecting the position of the alignment mark 75 of the screen 50. The position detection sensor 18 may detect a relative position between the projector PB and the screen 50 by using the position of the alignment mark 75 and send information about the detected position to the scanner controller 70. The scanner controller 70 may control the scanner 60 according to the position of the screen 50. The scanner controller 70 may adjust the scanning angle of the scanner 60 such that the grating pattern GP of the screen 50 and a pixel image signal of the optical modulator 15 may have a one-to-one match. For example, the scanner controller 70 may adjust the scanning angle of the scanner 60 such that a pixel image of the optical modulator 15 is properly aligned on the grating pattern GP of the screen 50.

As such, by accurately adjusting the scanning angle by using the alignment mark 75 of the screen 50 and the position detection sensor 18, the 3D image may be clearly displayed and position correction due to a movement or fluttering of the screen 50 may be performed.

In the following description, examples in which the 3D projection system according to an exemplary embodiment is applied to various apparatuses are described.

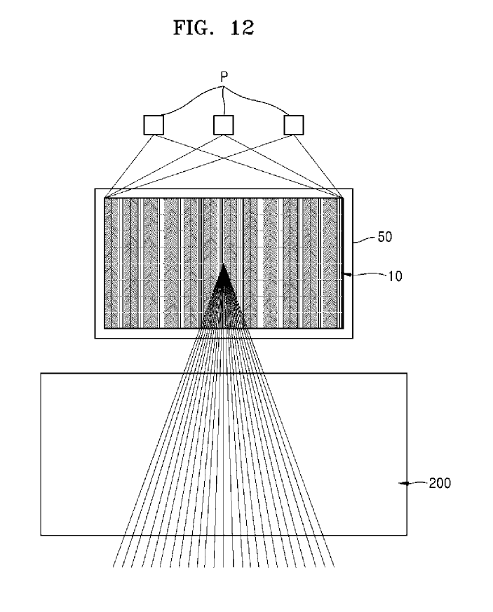

FIGS. 11 and 12 illustrate examples in which the 3D projection system according to the exemplary embodiment is applied as a 3D projection system for vehicle.

FIG. 11 illustrates an example of applying the screen 50 to a car front glass 200 according to an exemplary embodiment. In other words, the diffraction element 10 may be provided on the car front glass 200, and the projectors P1, P2, and P3 may be provided in a car to irradiate light having 3D image information toward the diffraction element 10 at an angle. In this case, for example, by using the 3D projection system according to an exemplary embodiment, a guidance image or images of a recognition camera may be displayed in a 3D image on the car front glass 200.

Referring to FIG. 12, the 3D projection system according to an exemplary embodiment may be arranged such that a 3D image diffracted by the diffraction element 10 is displayed on the car front glass 200. In this case, the projector P and the screen 50 may be arranged above a driver's seat or a dashboard of a car.

3D projection systems according to various exemplary embodiments may be arranged to be able to display a 3D image to other passengers, for example, one on a passenger seat next to the driver.

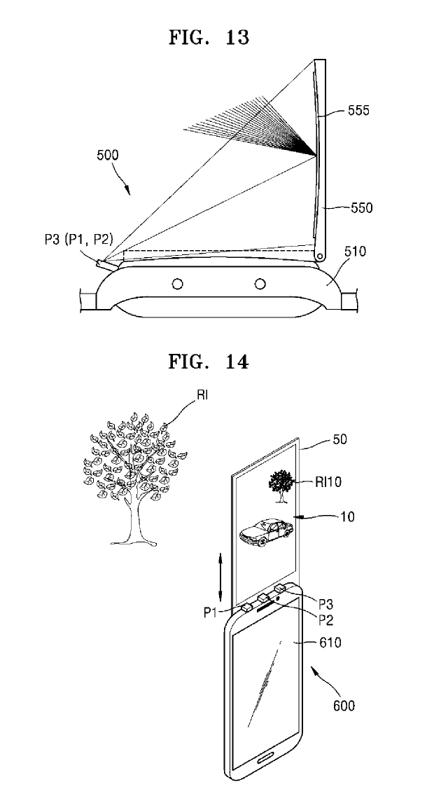

FIG. 13 illustrates an example in which a 3D projection system according to an exemplary embodiment is applied to a wrist-type mobile device.

Referring to FIG. 13, a screen 550 may be coupled to a wrist-type mobile device 500. For example, the screen 550 may be coupled to a body 510 of the wrist-type mobile device 500 as a foldable cover type. A plurality of the projectors P1, P2, and P3 may be arranged at one side of the body 510. When a diffraction element 555 is provided on the screen 550, and the screen 550 is unfolded, the light including the 3D image information generated by the projectors P1, P2, and P3 may be irradiated onto the diffraction element 555 of the screen 550 at an angle. In this case, the light including the 3D image information may display the 3D image by being diffracted by the diffraction element 555. In the exemplary embodiment, the screen 550 may be transparent and the diffraction element 555 may be of a semi-transmissive type. Accordingly, when the screen 550 is folded, a screen of the mobile device 500 may be seen through the screen 550.

FIG. 14 illustrates an example in which a 3D projection system according to an exemplary embodiment is applied to a smartphone.

Referring to FIG. 14, the screen 50 may be coupled to a smartphone 600, and the projectors P1, P2, and P3 may be provided on the smartphone 600. The screen 50 may be slidably coupled to the smartphone 600 or may be coupled thereto in a folder type. FIG. 14 illustrates that the screen 50 is slidably coupled to the smartphone 600.

For a 2D image, a display 610 of the smartphone 600 may be used without change. When a 3D image is formed, the screen 50 may be unfolded from the smartphone 600, and the light including the 3D image information irradiated by the projectors P1, P2, and P3 at an angle may be diffracted by the diffraction element 10, thereby displaying the 3D image. An image different from the image generated by the smartphone 600 may be generated as a 3D image through the projectors P1, P2, and P3. An image like the image of the smartphone 600 may be display as a 3D image through the projectors P1, P2, and P3. Furthermore, the 3D image information generated by the projectors P1, P2, and P3 is changed according to information of touching the display 610 of the smartphone 600, and thus, the 3D image may be enlarged or reduced.

When the screen 50 is of a transmissive type, the light having the 3D image information may be diffracted by the diffraction element 10 and the 3D image may be display in the front direction of the screen 50, and a see-through 3D projection system may be implemented in which a real object RI in the rear direction of the screen 50 may be seen through the screen 50 as a real object image RI 10.

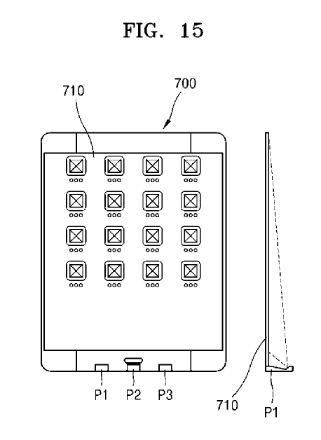

FIG. 15 illustrates an example in which a 3D projection system according to an exemplary embodiment is applied to a tablet 700. The left image of FIG. 15 is a plan view of a 3D projection system for a tablet and the right image of FIG. 15 is a side view of the 3D projection system for a tablet.

Referring to FIG. 15, grating pattern (not shown) is formed on a screen 710 of a tablet 700, and the projectors P1, P2, and P3 may be provided in a lower portion of the screen 710. The projectors P1, P2, and P3 may scan the light including the 3D image information onto the screen 710 of the tablet 700 at an angle. The light reflected from the screen 710 of the tablet 700 may be displayed as a multi-view 3D image. In this case, since an image output from the tablet 700 is not output at an angle with respect to the grating pattern of the screen 710, a diffraction operation is not performed and thus 2D image may be displayed.

Although FIG. 15 exemplarily illustrates that the projectors P1, P2, and P3 are arranged in the lower portion of the tablet 700, the position of the projector may be variously changed.

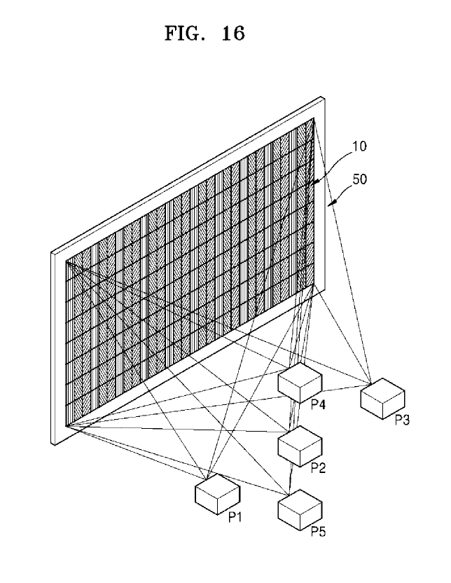

FIG. 16 illustrates an example in which a plurality of projectors are arranged in horizontal and vertical directions of the screen 50 in a 3D projection system according to an exemplary embodiment. For example, the first, second, and third projectors P1, P2, and P3 are arranged in the horizontal direction of the screen 50 and thus an angle of view in the horizontal direction is extended. Fourth and fifth projectors P4 and P5 are arranged in the vertical direction of the screen 50 and thus the angle of view in the vertical direction may be extended.

As described above, the 3D projection systems according to various embodiments may easily extend the angle of view according to the number of projectors. Furthermore, the number of views may be extended according to the number of projectors. The 3D projection system according to an embodiment may be applied to various devices such as mobile device or a vehicle and thus a 3D image may be displayed by being enlarged.

It should be understood that embodiments described herein should be considered in a descriptive sense only and not for purposes of limitation. Descriptions of features or aspects within each embodiment should typically be considered as available for other similar features or aspects in other embodiments.

The exemplary embodiments of the projector described herein may be implemented using hardware components, software components, or a combination thereof. The projector may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The projector may run an operating system (OS) and one or more software applications that run on the OS. The projector also may access, store, manipulate, process, and create data in response to execution of the software. For purpose of simplicity, the description of a projector is used as singular; however, one skilled in the art will appreciated that a processing device may include multiple processing elements and multiple types of processing elements. For example, the projector may include multiple processors or a processor and a controller. In addition, different processing configurations are possible, such a parallel processors.

The software may include a computer program, a piece of code, an instruction, or some combination thereof, to independently or collectively instruct or configure the controller or other processing elements of the projector to operate as desired. Software and data may be embodied permanently or temporarily in any type of machine, component, physical or virtual equipment, computer storage medium or device, or in a propagated signal wave capable of providing instructions or data to or being interpreted by the controller or other processing elements of the projector. The software also may be distributed over network coupled computer systems so that the software is stored and executed in a distributed fashion. The software and data may be stored by one or more non-transitory computer readable recording mediums.

The method according to the above-described example embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the example embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter. The described hardware devices may be configured to act as one or more software modules in order to perform the operations of the above-described example embodiments, or vice versa.

While one or more embodiments have been described with reference to the figures, it will be understood by those of ordinary skill in the art that various changes in form and details may be made therein without departing from the spirit and scope as defined by the following claims.

What is claimed is:

1. A three-dimensional (3D) projection system comprising:
a diffraction element comprising a grating pattern; and
a plurality of projectors configured to project light having image information onto the diffraction element, wherein the diffraction element displays a 3D image at multiple viewing points by adjusting a light exit direction based on an incident angle of the light projected by each of the plurality of projectors at the grating pattern.

2. The 3D projection system of claim 1, wherein each of the plurality of projectors comprises:
an illuminator configured to irradiating light;
an optical modulator configured to control the light in units of pixels, and
a controller configured to control the optical modulator to form an image.

3. The 3D projection system of claim 1, further comprising:
a screen which comprises the diffraction element.

4. The 3D projection system of claim 3, wherein the plurality of projectors are arranged at a left portion, a center portion and a right portion in a horizontal direction of the screen.

5. The 3D projection system of claim 3, wherein each of the plurality of projectors comprises a scanner configured to scan light including image information with respect to the screen.

6. The 3D projection system of claim 5, wherein each of the plurality of projectors further comprises:
an optical modulator having a plurality of pixels to form an image, and the plurality of pixels of the optical modulator are configured to have a one-to-one match with the grating pattern of the diffraction element.

7. The 3D projection system of claim 6, wherein each of the plurality of projectors further comprises a scanner controller configured to change a scanning angle of the scanner such that the grating pattern of the screen and pixel image signals of optical modulator have a one-to-one match.

8. The 3D projection system of claim 3, wherein the screen further comprises at least one alignment mark, and
each of the plurality of projectors comprises a position detection sensor configured to detect a position of the at least one alignment mark.

9. The 3D projection system of claim 3, wherein the plurality of projectors are arranged in a horizontal direction of the screen to form multi-view in the horizontal direction, and arranged in a vertical direction of the screen to form multi-view in the vertical direction.

10. The 3D projection system of claim 3, wherein the plurality of projectors are arranged to be spaced apart from the screen.

11. The 3D projection system of claim 2, wherein each of the plurality of projectors further comprises a beam adjustor configured to expand the light having the image information formed by the optical modulator.

12. The 3D projection system of claim 3, wherein the diffraction element is of a semi-transmissive type, and
wherein the diffraction element reflects the image formed by the plurality of projectors to be displayed in front of the screen and transmits a real object image to be displayed behind of the screen.

13. The 3D projection system of claim 3, wherein the screen corresponds to a car front glass and is implemented in a vehicle.

14. The 3D projection system of claim 3, wherein the screen and the plurality of projectors are provided in a vehicle, and a 3D image diffracted by the diffraction element of the screen is displayed on a car front glass.

15. The 3D projection system of claim 3, wherein the screen and the plurality of projectors are coupled to a mobile device.

16. The 3D projection system of claim 15, wherein the screen is slidably coupled to the mobile device or is coupled to the mobile device to be foldable.

17. The 3D projection system of claim 3, wherein the screen is opaque, and the light having the image information is diffracted by the diffraction element and the image is displayed in a front direction of the screen.

18. The 3D projection system of claim 3, wherein the diffraction element is integrally formed in the screen.

19. A three-dimensional (3D) projection system comprising:
a diffraction element comprising a grating pattern;
a first projector configured to project a first light having image information onto the diffraction element; and
a second projector configured to project a second light having the image information onto the diffraction element,
wherein light exit direction of the first light and the second light at the diffraction element are controlled based on an interaction between the first projection and the grating pattern, and based on an interaction between the second projector and the grating pattern.

20. A method for displaying a three-dimensional (3D) image comprising:
projecting, by a first projector, a first light having image information onto a diffraction element comprising a grating pattern; and
projecting, by a second projector, a second light having the image information onto the diffraction element,
wherein light exit direction of the first light and the second light at the diffraction element are controlled based on an interaction between the first projection and the grating pattern, and based on an interaction between the second projector and the grating pattern.
